(19) United States
(12) Patent Application Publication
(10) Pub. No.: US 2012/0039064 A1
(43) Pub. Date: Feb. 16, 2012

(54) LIGHT-EMITTING DEVICE

(75) Inventors: Yasunari OOYABU, Osaka (JP); Toshitaka NAKAMURA, Osaka (JP); Hironaka FUJII, Osaka (JP); Hisataka ITO, Osaka (JP)

(73) Assignee: NITTO DENKO CORPORATION, Osaka (JP)

(21) Appl. No.: 13/207,068

(22) Filed: Aug. 10, 2011

(30) Foreign Application Priority Data
Aug. 11, 2010 (JP) 2010-180197

(51) Int. Cl. F21V 9/16

(52) U.S. Cl. 362/84

(57) ABSTRACT

A light-emitting device includes a circuit board to which external electric power is supplied; a light emitting diode that is electrically connected onto the circuit board and emits light based on electric power from the circuit board; a housing provided on the circuit board so as to surround the light emitting diode and so that the upper end portion of the housing is positioned above the upper end portion of the light emitting diode; an adhesive layer that is provided on the housing, the adhesive layer being provided entirely in the circumferential direction of the housing, and the adhesive layer having a length from the inner circumferential edge to the outer circumferential edge of mainly 0.3 mm or more and a thickness of 200 μm or less; and a phosphor ceramic that is allowed to adhere onto the housing with the adhesive layer interposed therebetween.

### CROSS-REFERENCE TO RELATED APPLICATION

The present application claims priority from Japanese Patent Application No. 2010-180197 filed on Aug. 11, 2010, the contents of which are hereby incorporated by reference into this application.

### BACKGROUND OF THE INVENTION

1. Field of the Invention

The present invention relates to a light-emitting device including a light emitting diode.

2. Description of Related Art

Conventionally, a white LED has been known: in the white LED, a blue LED is covered with a YAG phosphor which receives blue light and emits yellow light, and white light is obtained by mixing colors of blue light from the blue LED, and yellow light from the YAG phosphor.

For example, Japanese Unexamined Patent Publication No. 2010-27704 has proposed a light-emitting device including a substrate to which an LED element is connected onto; a cylindrical formwork connected onto the substrate so as to surround the LED element; and a phosphor ceramic plate that is mounted on the upper end of the formwork with an anchoring material (an adhesive such as a low melting point glass) interposed therebetween.

In such a light-emitting device, when the phosphor ceramic plate emits light by receiving light from the LED element, the phosphor ceramic plate generates heat.

### SUMMARY OF THE INVENTION

However, in the above-described Japanese Unexamined Patent Publication No. 2010-27704, the light-emitting device is disadvantageous in that the heat generation of the phosphor ceramic plate causes a decrease in light emission efficiency of the phosphor ceramic plate.

Thus, an object of the present invention is to provide a light-emitting device with which heat-releasing characteristics of the phosphor ceramic can be improved, and a decrease in light emission efficiency of the phosphor ceramic can be suppressed.

A light-emitting device of the present invention includes: a circuit board to which external electric power is supplied; a light emitting diode that is electrically connected onto the circuit board and emits light based on electric power from the circuit board; a housing that is provided on the circuit board so as to surround the light emitting diode and so that the upper end portion of the housing is positioned above the upper end portion of the light emitting diode; an adhesive layer that is provided on the housing, the adhesive layer being provided entirely in the circumferential direction of the housing, and the adhesive layer having a length from the inner circumferential edge to the outer circumferential edge of mainly 0.3 mm or more and a thickness of 200 μm or less; and a phosphor ceramic that is allowed to adhere onto the housing with the adhesive layer interposed therebetween.

With a light-emitting device of the present invention, the phosphor ceramic is allowed to adhere to the housing with the adhesive layer having a length from the inner circumferential edge to the outer circumferential edge of 0.3 mm or more and a thickness of 200 μm or less interposed therebetween.

Therefore, heat from the phosphor ceramic can be efficiently transmitted to the housing and can be dissipated through the housing.

As a result, heat-releasing characteristics of the phosphor ceramic can be improved, and a decrease in light emission efficiency of the phosphor ceramic can be suppressed.

### BRIEF DESCRIPTION OF THE DRAWINGS

FIG. 1 is a cross sectional view illustrating an embodiment of a light-emitting device of the present invention.

FIG. 2 is a cross sectional view taken along line A-A of the light-emitting device shown in FIG. 1.

### DETAILED DESCRIPTION OF THE INVENTION

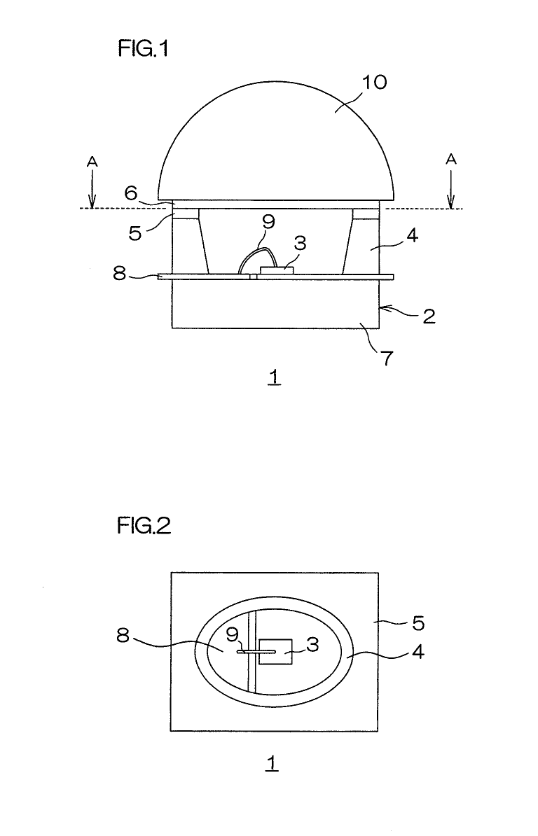

FIG. 1 is a cross sectional view illustrating an embodiment of the light-emitting device of the present invention. FIG. 2 is a cross sectional view taken along line A-A of the light-emitting device shown in FIG. 1.

A light-emitting device 1 includes, as shown in FIGS. 1 and 2, a circuit board 2, a light emitting diode 3, a housing 4, an adhesive layer 5, and a phosphor ceramic plate 6 as an example of the phosphor ceramic.

The circuit board 2 includes a base substrate 7, and a wiring pattern 8 formed on the top face of the base substrate 7. External electric power is supplied to the circuit board 2, to be specific, to the wiring pattern 8.

The base substrate 7 is formed into a generally rectangular flat plate when viewed from the top, and is formed from, for example, a metal such as aluminum, for example, a ceramic such as alumina, for example, polyimide resin, or the like.

The base substrate 7 has a thermal conductivity of, for example, 5 W/m·K or more, or preferably 10 W/m·K or more.

When the base substrate 7 is formed from metal, to prevent a short circuit between the base substrate 7 and the wiring pattern 8, an insulating layer is provided between the base substrate 7 and the wiring pattern 8. Even if the thermal conductivity of the insulating layer is low (e.g., 5 W/m·K or less), as long as the thermal conductivity of the base substrate 7 is within the above-described range, heat from the phosphor ceramic plate 6 can be efficiently transmitted to the housing 4.

The reflectivity of the base substrate 7 for light from the emitting diode 3 is set to, at least in a region (region surrounded by the housing 4) where the light emitting diode 3 is mounted, for example, 70% or more, preferably 90% or more, or more preferably 95% or more.

In the region (region surrounded by the housing 4) where the light emitting diode 3 is mounted, for example, a resin coating in which a white filler is dispersed may be provided on the surface of the base substrate 7 in an attempt to further improve reflectivity.

The wiring pattern 8 electrically connects a terminal of the light-emitting diode 3, and a terminal (not shown) of a power source (not shown) for supplying electric power to the light-emitting diode 3. The wiring pattern 8 is formed from, conductive materials such as, for example, copper and iron.

The wiring pattern 8 has a thermal conductivity of, for example, 5 W/m·K or more, or preferably 10 W/m·K or more.

The reflectivity of the wiring pattern 8 for light from the light emitting diode 3 is set to, at least in the region (region surrounded by the housing 4) where the light emitting diode 3 is mounted, for example, 70% or more, preferably 90% or more, or more preferably 95% or more.

The light emitting diode 3 is, to be specific, a blue LED, and is provided on the base substrate 7. The light emitting diode 3 is electrically connected (wire bonded) onto the wiring pattern 8 through a wire 9. The light emitting diode 3 emits light based on electric power from the circuit board 2.

The housing 4 is arranged so that the upper end portion thereof is positioned above the upper end portion of the light emitting diode 3, and so as to stand upward from the top face of the base substrate 7; and is formed into a frame shape, when viewed from the top, so as to surround the light emitting diode 3. The housing 4 is formed to have a tapered cross section so that the cross sectional area of its opening increases from the lower side toward upper side.

The housing 4 is formed from the following examples of materials: oxide ceramic materials such as alumina, zirconia, and yttria; nitride ceramic materials such as aluminum nitrides; and metal materials such as Cu materials (e.g., Cu—Fe—P) and Fe materials (e.g., Fe-42% Ni). The housing 4 is formed from, preferably a ceramic material, or more preferably alumina.

When the housing 4 is formed from the above-described materials, improvement in thermal conductivity, as well as improvement in reflectivity can be achieved.

When the housing 4 is formed from metal materials, for example, a resin coating in which a white filler is dispersed may be provided in an attempt to further improve reflectivity.

The housing 4 has a thermal conductivity of, for example, 5 W/m·K or more, preferably 15 W/m·K or more, or more preferably 100 W/m·K or more.

The reflectivity of the housing 4 for light from the light emitting diode 3 is set to, for example, 70% or more, preferably 90% or more, or more preferably 95% or more.

The housing 4 is formed so that its length from the inner circumferential edge to the outer circumferential edge at its upper end face is, for example, 0.3 mm or more, or preferably 1 mm or more, and generally is 5 mm or less.

As long as the above-described length is ensured, a step into which the phosphor ceramic plate 6 is fitted may be formed on the upper end face of the housing 4.

The housing 4 may also be formed in advance integrally with the circuit board 2, i.e., as a circuit board having a housing. Examples of the circuit board having a housing include a commercially available product, for example, a multilayer ceramic substrate having a cavity (product number: 207806, manufactured by Sumitomo Metal (SMI) Electronics Devices Inc.).

The housing 4 is filled, as necessary, for example, with silicone resin, epoxy resin, or a hybrid resin of those as a sealing material. Silicone resin is preferably used. When the housing 4 is filled with the sealing material, confinement of light emitted from the light emitting diode 3 due to total reflection can be reduced.

The adhesive layer 5 has sufficient adhesive strength relative to both of the phosphor ceramic plate 6 and the housing 4; is composed of a material having sufficient heat resistance relative to the temperature of the phosphor ceramic plate 6 or the housing 4 while at least the light-emitting device 1 is driving; and is provided on the upper end face of the housing 4 entirely in the circumferential direction of the housing 4.

Examples of adhesives that form the adhesive layer 5 include an adhesive made of epoxy resin, silicone resin, or acrylic resin.

The adhesive layer 5 is formed so that the length (hereinafter referred to as overlap width) from the inner circumferential edge to the outer circumferential edge is, for example, 0.3 mm or more, preferably 0.3 to 5 mm, or more preferably 0.3 to 2 mm.

In the overlap width of the adhesive layer 5, for example, 80% or more, or preferably 90% or more of the circumferential direction length (inner circumference based) of the adhesive layer 5 is within the above-described range.

As long as the overlap width of the adhesive layer 5 is within the above-described range, heat from the phosphor ceramic plate 6 can be efficiently transmitted to the housing 4 through the adhesive layer 5, and can be dissipated through the housing 4.

The adhesive layer 5 has a thickness of, for example, 200 μm or less, preferably 100 μm or less, or more preferably 50 μm or less, and usually 5 μm or more.

As long as the thickness of the adhesive layer 5 is within the above-described range, heat from the phosphor ceramic plate 6 can be efficiently transmitted to the housing 4 through the adhesive layer 5, and can be dissipated through the housing 4. Furthermore, incorporation of impurities such as moisture and sulfur from the edge portion can be suppressed. Also, leakage of emitted light from the adhesive layer 5 can be suppressed.

A filler such as alumina, titanium oxide, zirconium oxide, barium titanate, carbon, and silver may be added to the adhesive layer 5 as necessary, to an extent that will not damage adhesive strength. When a filler is added to the adhesive layer 5, thermal conductivity of the adhesive layer 5 can be improved.

The adhesive layer 5 has a thermal conductivity of, for example, 0.1 W/m·K or more, preferably 0.2 W/m·K or more, or more preferably 1.0 W/m·K or more.

The phosphor ceramic plate 6 is allowed to adhere onto the housing 4 with the adhesive layer 5 interposed therebetween so as to close the region surrounded by the housing 4.

The phosphor ceramic plate 6 contains a phosphor material that is excited by absorbing a portion or entirety of light of wavelength from 350 to 480 nm as excitation light, and emits light of wavelength longer than that of excitation light, for example, fluorescent light of 500 to 650 nm.

Examples of phosphor materials include garnet phosphor materials having a garnet crystal structure such as Y₃Al₅O₁₂:Ce (YAG (yttrium.aluminum.garnet):Ce), (Y,Gd)₃Al₅O₁₂:Ce, Tb₃Al₃O₁₂:Ce, Ca₃Sc₂Si₃O₁₂:Ce, and Lu₂CaMg₂(Si,Ge)₃O₁₂:Ce; silicate phosphor materials such as (Sr,Ba)₂SiO₄:Eu, Ca₃SiO₄Cl₂:Eu, Sr₃SiO₅:Eu, Li₂SrSiO₄:Eu, and Ca₃Si₂O₇:Eu; aluminate phosphor materials such as CaAl₁₂O₁₉:Mn and SrAl₂O₄:Eu; sulfide phosphor materials such as ZnS:Cu,Al, CaS:Eu, CaGa₂S₄:Eu, and SrGa₂S₄:Eu; oxynitride phosphor materials such as CaSi₂O₂N₂:Eu, SrSi₂O₂N₂:Eu, BaSi₂O₂N₂:Eu, and Ca-α-SiAlON; nitride phosphor materials such as CaAlSiN₃:Eu and CaSi₅N₈:Eu; and fluoride phosphor materials such as K₂SiF₆:Mn and K₂TiF₆:Mn. Preferably, a garnet phosphor material is used, or more preferably, Y₃Al₅O₁₂:Ce is used.

The phosphor ceramic plate 6 preferably has translucency, i.e., allows light to pass through.

To produce the phosphor ceramic plate 6, first, phosphor material particles made of a phosphor material is produced.

To produce the phosphor material particles, in the case of forming Y₃Al₅O₁₂:Ce as a phosphor material, a precursor solution is prepared by dissolving, for example, a yttrium-containing compound such as yttrium nitrate hexahydrate, for example, an aluminum-containing compound such as aluminum nitrate nonahydrate, and, for example, a cerium-containing compound such as cerium nitrate hexahydrate in a solvent such as distilled water at a predetermined ratio.

To prepare the precursor solution, a yttrium-containing compound, an aluminum-containing compound, and a cerium-containing compound are blended so that the amount of aluminum atoms is, for example, 120 to 220 mol, or preferably 160 to 180 mol, and the amount of cerium atoms is, for example, 0.01 to 2.0 mol, or preferably 0.2 to 1.5 mol relative to 100 mol of yttrium atoms; and the mixture is dissolved in a solvent.

Then, the precursor solution is sprayed to be pyrolyzed, thereby producing precursor particles. Although the precursor particles may be used as is as phosphor material particles, the phosphor material particles may be temporarily calcined preferably at, for example, 1000 to 1400° C., or more preferably at 1150 to 1300° C., and for, for example, 0.5 to 5 hours, or preferably 1 to 2 hours, to be served as phosphor material particles.

By temporarily calcining the precursor particles, the crystal phase of the obtained phosphor material particles can be adjusted, and a high density phosphor ceramic plate 6 can be obtained.

The obtained phosphor material particles had an average particle size (measured by BET (Brunauer-Emmett-Teller) method using an automatic specific surface area measurement apparatus (model Gemini 2365, manufactured by Micromeritics Instrument Corporation)) of, for example, 50 to 10000 nm, preferably 50 to 1000 nm, or more preferably, 50 to 500 nm.

To measure the average particle size of the phosphor material particles, other than the above-described BET method, for example, methods such as a laser diffraction method, and direct observation using an electron microscope may be used. The obtained phosphor material particles may be classified so that large size particles having a particle size larger than the above-described average particle size can also be removed.

When the average particle size of the phosphor material particles is within the above-described range, the phosphor ceramic plate 6 can be made to have a high density, dimensional stability at the time of sintering can be improved, and void generation can be decreased.

Examples of phosphor material particles also include a mixture of yttrium-containing particles such as yttrium oxide particles, aluminum-containing particles such as aluminum oxide particles, and cerium-containing particles such as cerium oxide particles.

When such a mixture is used, yttrium-containing particles, aluminum-containing particles, and cerium-containing particles are mixed so that the amount of aluminum atoms is, for example, 120 to 220 mol, or preferably 160 to 180 mol, and the amount of cerium atoms is, for example, 0.01 to 2.0 mol, or preferably 0.2 to 1.5 mol relative to 100 mol of yttrium atoms.

Next, to prepare the phosphor ceramic plate 6, a ceramic green body made of phosphor material particles is produced.

To produce a ceramic green body, for example, phosphor material particles are pressed using a mold.

The ceramic green body may also be made, for example, by first preparing a dispersion liquid of phosphor material particles by dispersing phosphor material particles in a volatile solvent of for example, an aromatic solvent such as xylene, or for example, alcohol such as methanol, appropriately using additives such as a binder resin, a dispersing agent, a plasticizer, and a sintering auxiliary agent; then preparing powder containing the phosphor material particles and the additives by drying the dispersion liquid of phosphor material particles, for example, by spray drying; and then pressing the powder.

To disperse the phosphor material particles in a solvent, in addition to the above-described additives, known additives may be used without particular limitation as long as the additive is decomposed by heat.

Examples of the methods for dispersing phosphor material particles in a solvent include wet mixing using a known dispersing tools such as mortars, various mixers, ball mills, and bead mills.

To produce the ceramic green body, for example, phosphor material particle dispersion liquid, after adjusting its viscosity as necessary, for example, is subjected to tape casting by the doctor blade method, or extrusion molding on a resin substrate such as a PET film, and then dried. When using the doctor blade method, the thickness of the ceramic green body is controlled by adjusting the gap of the doctor blade.

When an additive such as binder resin is blended to the phosphor material particle dispersion liquid, before calcining the ceramic green body, the ceramic green body is heated in air at, for example, 400 to 800° C., for, for example, 1 to 10 hours, thereby performing a binder removal process to decompose and remove the additive. At this time, the temperature rising speed is, for example, 0.2 to 2.0° C./min. As long as the temperature rising speed is within the above-described range, deformation or cracks of the ceramic green body can be prevented.

Next, to produce the phosphor ceramic plate 6, the ceramic green body is calcined.

The calcining temperature, time, and calcining atmosphere are set appropriately according to the phosphor material. When the phosphor material is Y₃Al₅O₁₂:Ce, the calcining is performed at, for example, 1500 to 1800° C., or preferably 1650 to 1750° C., for, for example, 0.5 to 24 hours, or preferably 3 to 5 hours in vacuum in an inert gas atmosphere such as argon, or in a reducing gas such as hydrogen and a hydrogen/nitrogen mixture gas.

When calcining in a reduction atmosphere, carbon particles may be used along with the reducing gas. When the carbon particles are used together, reducing properties can further be improved.

The temperature rising speed until reaching the calcining temperature is, for example, 0.5 to 20° C./min. As long as the temperature rising speed is within the above-described range, the temperature can be increased efficiently, while crystal grains can be grown relatively mildly, which suppressed void generation. To further achieve a high density phosphor ceramic plate 6, and to improve translucency, the sintering is performed under pressure by the hot isostatic pressing sintering method (HIP method).

The phosphor ceramic plate 6 is obtained in this manner.

The thickness of the obtained phosphor ceramic plate 6 is, for example, 100 to 1000 μm, or preferably 150 to 500 μm.

As long as the thickness of the phosphor ceramic plate 6 is within the above-described range, improvement in handleability, and prevention of damage can be achieved.

The obtained phosphor ceramic plate 6 has a total luminous transmittance (at 700 nm) of, for example, 30 to 90%, or preferably 60 to 80%.

The obtained phosphor ceramic plate 6 has a thermal conductivity of, for example, 5 W/m·K or more, or preferably 10 W/m·K or more.

The phosphor ceramic plate 6 can also be produced by selecting one or more of any of the above-described phosphor materials so that the light emitted from the light-emitting device 1 can be adjusted to an arbitrary color. To be specific, the phosphor ceramic plate 6 may be formed from a phosphor material that emits green light to obtain a light-emitting device 1 that emits green light, or a phosphor material that emits yellow light may be used in combination with a phosphor material that emits red light to obtain a light-emitting device 1 that emits light having a color similar to that of an electric light bulb.

On the housing 4, as necessary, a generally semispheric shape (generally dome-shaped) lens 10 may be placed so as to cover the phosphor ceramic plate 6. The lens 10 is formed from, for example, a transparent resin such as silicone resin.

To produce the light-emitting device 1, first, the housing 4 is provided on the circuit board 2. Then, the light emitting diode 3 is placed in the housing 4, and the light emitting diode 3 is electrically connected onto the circuit board 2 through the wire 9.

Then, the interior of the housing 4 is filled with a sealing material as necessary, and the phosphor ceramic plate 6 is placed on the housing 4 with the adhesive layer 5 interposed therebetween.

To place the adhesive layer 5 on the housing 4, the above-described adhesive is applied to the upper end face of the housing 4 so as to give the above-described thickness and/or overlap width.

At that time, the adhesive layer 5 may be provided on the entire upper end face of the housing 4, or may be provided on a portion (in the proximity of the inner circumference, in the proximity of the outer circumference, or at the center portion) of the upper end face of the housing 4.

The adhesive layer 5 may also be provided, first, by applying an adhesive on the entire face of the phosphor ceramic plate 6, and thereafter, connecting the phosphor ceramic plate 6 to which the adhesive is applied onto the housing 4 (and on to the sealing material).

Then, on the phosphor ceramic plate 6, the lens 10 is placed via an adhesive as necessary, thereby completing the production of the light-emitting device 1.

On the reverse face of the base substrate 7, as necessary, a heat sink (not shown) is provided.

In this light-emitting device 1, the phosphor ceramic plate 6 is allowed to adhere to the housing 4 with the adhesive layer 5 having an overlap width of mainly 0.3 mm or more and a thickness of 200 μm or less.

Therefore, the heat conduction distance (that is, the thickness of the adhesive layer 5) from the phosphor ceramic plate 6 to the housing 4 through the adhesive layer 5 can be decreased, and a heat conduction path width (that is, the overlap width of the adhesive layer 5) from the phosphor ceramic plate 6 to the housing 4 through the adhesive layer 5 can be ensured.

Thus, heat from the phosphor ceramic plate 6 can be efficiently transmitted to the housing 4, and can be dissipated through the housing 4.

As a result, heat-releasing characteristics of the phosphor ceramic plate 6 can be improved, and a decrease in light emission efficiency of the phosphor ceramic plate 6 can be suppressed.

Although a light-emitting device 1 having one light emitting diode 3 is illustrated in the above-description, the number of the light emitting diodes 3 included in the light-emitting device 1 is not particularly limited, and the light-emitting device 1 may also be formed to include, for example, a plurality of light emitting diodes 3 arranged in a planar (two-dimensional) or linear (one-dimensional) array.

The shape of the housing 4 is not particularly limited, and for example, the housing 4 may be formed into a generally rectangular frame shape, or into a generally circular frame shape.

Furthermore, although a semispheric shape lens 10 is provided on the phosphor ceramic plate 6 in the above-described embodiment, for example, a microlens array sheet, or a diffusion sheet may be provided instead of the lens 10.

This light-emitting device 1 is suitably used, for example, as a power LED light source in which high brightness and high output are needed: the device may be used for, for example, backlight for a large size liquid crystal display, various lighting apparatuses, headlights for automobiles, advertizing signs, and flashlight for digital cameras.

### EXAMPLES

In the following, the present invention is described by way of Examples and Comparative Examples, but the present invention is not limited thereto.

### 1. Production of Phosphor Ceramic Plate

### (1) Production of Phosphor Material Particles

0.4M of a precursor solution was prepared by dissolving 14.349 g (0.14985 mol) of yttrium nitrate hexahydrate, 23.45 g (0.25 mol) of aluminum nitrate nonahydrate, and 0.016 g (0.00015 mol) of cerium nitrate hexahydrate in 250 ml of distilled water.

This precursor solution was sprayed in high-frequency (RF) induction plasma flame by using a two-fluid nozzle at a speed of 10 mL/min to be pyrolyzed, thereby producing precursor particles.

The crystal phase of the obtained precursor particles was analyzed by the X-ray diffraction method, and the result showed a mixed phase of an amorphous phase and YAP (yttrium.aluminum.perovskite, YAlO₃) crystal.

The average particle size of the obtained precursor particles measured by the BET ((Brunauer-Emmett-Teller) method using an automatic specific surface area measurement apparatus (model Gemini 2365, manufactured by Micromeritics Instrument Corporation)) was about 75 nm.

Then, the obtained precursor particles were introduced into an alumina-made crucible, and temporarily calcined in an electric furnace at 1200° C. for 2 hours, thereby producing phosphor material particles.

The obtained phosphor material particles had a single crystal phase of YAG (yttrium.aluminum.garnet).

The average particle size of the obtained phosphor material particles was about 95 nm.

### (2) Preparation of Phosphor Material Particles Dispersion Liquid

4 g of the obtained phosphor material particles, 0.21 g of poly(vinyl butyl-co-vinyl alcohol-co-vinyl alcohol) as binder resin, 0.012 g of silica powder (manufactured by Cabot Corporation) as a sintering auxiliary agent, and 10 ml of methanol as a solvent were mixed in a mortar.

A phosphor material particles dispersion liquid in which the phosphor material particles were dispersed was prepared in this manner.

### (3) Preparation of Ceramic Green Body

The obtained phosphor material particles dispersion liquid was dried with a dryer, thereby producing powder. The powder in an amount of 700 mg was injected into a uniaxial press mold having a size of 20 mm×30 mm, and then compressed with a hydraulic press by a pressure of about 10 kN, thereby producing a generally rectangular ceramic green body having a thickness of about 350 μm.

### (4) Calcining of Ceramic Green Body

The obtained ceramic green body was heated in an alumina-made tubular electric furnace in air at a temperature rising speed of 2° C./min up to 800° C., and a binder removal process to decompose and remove organic components such as binder resin and the like was performed.

Thereafter, the alumina-made tubular electric furnace was evacuated with a rotary pump, and calcining was performed at 1500° C. for 5 hours, thereby producing a phosphor ceramic plate.

The obtained phosphor ceramic plate had a thickness of about 280 μm.

### 2. Production of Light Emitting Diode Element for Evaluation

### Example 1

A blue LED chip (manufactured by Cree, Inc., product number C450EZ1000-0123, 980 μm×980 μm×100 μm) was die attached in a cavity of a multilayer ceramic substrate having a cavity (manufactured by Sumitomo Metal (SMI) Electronics Devices Inc., product number 207806, external size: 3.5 mm×2.8 mm, cavity: generally ellipsoid, major axis 2.68 mm, minor axis 1.98 mm, and height of the housing 0.6 mm, housing material: alumina, thermal conductivity: 17 μm·k, reflectivity: 75%) by Au—Sn solder, and Au wire was used to wire bond from the electrode of the light emitting diode chip to the lead frame of the multilayer ceramic substrate, thereby producing a light emitting diode package on which one blue LED chip was mounted.

Separately, the phosphor ceramic plate was cut out into a size of 3.5 mm×2.8 mm, so as match the external size of the multilayer ceramic substrate.

Then, a thermosetting liquid epoxy resin (product number NT8080, manufactured by Nitto Denko Corporation) was applied as an adhesive near the inner circumference of the upper end face of the housing of the multilayer ceramic substrate, and a phosphor ceramic plate was placed thereon.

Thereafter, the heating was performed at 120° C. for 1 minute, and further at 135° C. for 4 hours to cure the adhesive, thereby forming an adhesive layer. The phosphor ceramic plate was allowed to adhere to the housing with the adhesive layer interposed therebetween in this manner.

A light emitting diode element was obtained in this manner. The overlap width and the thickness (measured by a micrometer) of the adhesive layer are shown in Table 1.

### Example 2

A light emitting diode element was obtained in the same manner as in Example 1, except that the interior of the cavity of the multilayer ceramic substrate was filled with a gelled silicone resin (product name: WACKER SilGel 612 manufactured by WACKER ASAHIKASEI SILICONE CO., LTD.), and the heating was performed at 100° C. for 15 minutes so that the gelled silicone resin was cured. The overlap width and the thickness (measured by a micrometer) of the adhesive layer are shown in Table 1.

### Example 3

A light emitting diode element was obtained in the same manner as in Example 1, except that a thermosetting silicone elastomer resin (product number: KER-2500, manufactured by Shin-Etsu Chemical Co., Ltd.) was used as the adhesive, and the heating was performed at 100° C. for 1 hour, and further at 150° C. for 1 hour so that the adhesive was cured. The overlap width and the thickness (measured by a micrometer) of the adhesive layer are shown in Table 1.

### Example 4

A light emitting diode element was obtained in the same manner as in Example 3, except that the thickness of the adhesive layer was adjusted as described in Table 1. The overlap width and the thickness (measured by a micrometer) of the adhesive layer are shown in Table 1.

### Example 5

A light emitting diode element was obtained in the same manner as in Example 3, except that the thickness of the adhesive layer was adjusted as described in Table 1. The overlap width and the thickness (measured by a micrometer) of the adhesive layer are shown in Table 1.

### Example 6

A light emitting diode element was obtained in the same manner as in Example 3, except that barium titanate particles (product number: BT-03, adsorption specific surface area: 3.7 g/m², manufactured by SAKAI CHEMICAL INDUSTRY CO., LTD.) was added as the filler to the adhesive in an amount of 60 mass % relative to the total amount of the adhesive and the barium titanate particles. The overlap width and the thickness (measured by a micrometer) of the adhesive layer are shown in Table 1.

### Comparative Example 1

A light emitting diode element was obtained in the same manner as in Example 3, except that the thickness of the adhesive layer was adjusted as described in Table 1. The overlap width and the thickness (measured by a micrometer) of the adhesive layer are shown in Table 1.

### Comparative Example 2

A light emitting diode element was obtained in the same manner as in Example 3, except that the thickness of the adhesive layer was adjusted as described in Table 1. The overlap width and the thickness (measured by a micrometer) of the adhesive layer are shown in Table 1.

### Comparative Example 3

A light emitting diode element was obtained in the same manner as in Example 6, except that the thickness of the adhesive layer was adjusted as described in Table 1. The overlap width and the thickness (measured by a micrometer) of the adhesive layer are shown in Table 1.

### Comparative Example 4

A light emitting diode element was obtained in the same manner as in Example 3, except that the phosphor ceramic plate was cut out to a size of 2.9 mm×2.2 mm, and the overlap width was adjusted as described in Table 1. The overlap width and the thickness (measured by a micrometer) of the adhesive layer are shown in Table 1.

The adhesive layer was formed on the entire surface of the upper end face of the housing, and the phosphor ceramic plate was mounted on the adhesive layer so as to close a generally ellipsoid cavity having a major axis of 2.68 mm and a minor axis of 1.98 mm. Then, a portion where the phosphor ceramic plate, the adhesive layer, and the housing are overlapped with each other when projected in a vertical direction was used as the overlapped portion, and the remaining portion of the adhesive layer was allowed to be exposed.

### Comparative Example 5

A light emitting diode element was obtained in the same manner as in Comparative Example 4, except that the phosphor ceramic plate was cut out to a size of 3.1 mm×2.4 mm, and the overlap width was adjusted as described in Table 1. The overlap width and the thickness (measured by a micrometer) of the adhesive layer are shown in Table 1.

### Comparative Example 6

A light emitting diode element was obtained in the same manner as in Example 1, except that the phosphor ceramic plate was mounted on the housing with cotton cloth having a thickness of 500 μm interposed therebetween instead of the adhesive layer.

### Comparative Example 7

A solution in which 20 mass % of commercially available YAG phosphor powder (product number BYW01A, average particle size 9 μm, manufactured by Phosphor Tech Corporation) was dispersed in a thermosetting silicone elastomer relative to the total amount of the thermosetting silicone elastomer and the YAG phosphor powder was applied using an applicator on a PET film to give a thickness of about 200 μm, and the solution was heated at 100° C. for 1 hour, and then at 150° C. for 1 hour, thereby producing a phosphor-dispersed resin sheet.

Then, a light emitting diode element was obtained in the same manner as in Example 3, except that the phosphor-dispersed resin sheet was used instead of the phosphor ceramic plate. The overlap width and the thickness (measured by a micrometer) of the adhesive layer are shown in Table 1.

### Reference Examples 1 and 3

A light emitting diode package only was prepared in the same manner as in Example 1.

### Reference Example 2

A light emitting diode package was prepared in the same manner as in Example 1; a gelled silicone resin (product name: WACKER SilGel 612, manufactured by WACKER ASAHIKASEI SILICONE CO., LTD.) was injected into the cavity of the multilayer ceramic substrate so that a blue LED and Au wire were embedded therein; and the gelled silicone resin was heated at 100° C. for 15 minutes so that the gelled silicone resin was cured.

Then, the phosphor ceramic plate was cut out into a size of 1.5 mm×1.5 mm, and mounted right above the blue LED in the housing.

### 3. Temperature Measurement of Phosphor Ceramic Plate Surface

In the light-emitting devices obtained in Examples, Comparative Examples, and Reference Examples, an electric current of 1 A was applied to the light emitting diodes and the temperatures were measured using an infrared camera (product name Infrared Camera A325 manufactured by FLIR Systems, Inc.). The temperatures of the following were measured: the phosphor ceramic plates (Examples, Comparative Examples, and Reference Example 2), the housing (Reference Example 3), and the blue LED chip (Reference Example 1). The results are shown in Table 1.

TABLE 1

| | | | | | Surface |
|---|---|---|---|---|---|
| | | Adhesive Layer | | | Tem- |
| | | | Overlap | Thick- | per- |
| | | | Width | ness | ature |
| | Phosphor | Adhesive | (mm) | (μm) | (° C.) |
| Example 1 | Phosphor | Epoxy Resin | 0.4 | 20 | 79 |
| Example 2 | Ceramic | Epoxy Resin | 0.4 | 20 | 74 |
| Example 3 | Plate | Silicone Resin | 0.4 | 50 | 79 |
| Example 4 | | Silicone Resin | 0.4 | 100 | 84 |
| Example 5 | | Silicone Resin | 0.4 | 150 | 91 |
| Example 6 | | Filler-dispersed | 0.4 | 50 | 74 |
| | | Silicone Resin | | | |
| Comp. Ex. 1 | | Silicone Resin | 0.4 | 250 | 112 |
| Comp. Ex. 2 | | Silicone Resin | 0.4 | 400 | 136 |
| Comp. Ex. 3 | | Filler-dispersed | 0.4 | 250 | 119 |
| | | Silicone Resin | | | |
| Comp. Ex. 4 | | Silicone Resin | 0.1 | 50 | 163 |
| Comp. Ex. 5 | | Silicone Resin | 0.2 | 50 | 114 |
| Comp. Ex. 6 | | —(Cotton Cloth) | — | About | 182 |
| | | | | 500 | |
| Comp. Ex. 7 | Phosphor | Silicone Resin | 0.4 | 50 | >300 |
| | Dispersed | | | | |
| | Sheet | | | | |
| Reference | — | — | — | — | 114 |
| Example 1 | | | | | |
| Reference | Phosphor | — | — | — | 179 |
| Example 2 | Ceramic | | | | |
| | Plate | | | | |
| Reference | — | — | — | — | 60 |
| Example 3 | | | | | |

While the illustrative embodiments of the present invention are provided in the above description, such is for illustrative purpose only and it is not to be construed as limiting the scope of the present invention. Modifications and variations of the present invention that will be obvious to those skilled in the art are to be covered by the following claims.

What is claimed is:

1. A light-emitting device comprising:
a circuit board to which external electric power is supplied;
a light emitting diode that is electrically connected onto the circuit board and emits light based on electric power from the circuit board;
a housing that is provided on the circuit board so as to surround the light emitting diode and so that the upper end portion of the housing is positioned above the upper end portion of the light emitting diode;
an adhesive layer that is provided on the housing,
the adhesive layer being provided entirely in the circumferential direction of the housing, and
the adhesive layer having a length from the inner circumferential edge to the outer circumferential edge of mainly 0.3 mm or more and a thickness of 200 μm or less; and
a phosphor ceramic that is allowed to adhere onto the housing with the adhesive layer interposed therebetween.
